(19) United States
(12) Patent Application Publication
(10) Pub. No.: US 2011/0234414 A1
(43) Pub. Date: Sep. 29, 2011

(54) WEARABLE LIVE ELECTRICAL CIRCUIT DETECTION DEVICE

(76) Inventors: Luis Ojeda, Richland, WA (US); John M. Bozich, Richland, WA (US)

(21) Appl. No.: 12/732,832

(22) Filed: Mar. 26, 2010

(51) Int. Cl. G08B 21/00

(52) U.S. Cl. 340/635

(57) ABSTRACT

A wearable electrical circuit detection device is provided with a plurality of modules configured to functionally execute the necessary steps of detecting an energized electrical circuit. These modules include a wearable holder worn at or near a finger, a sensing module positioned on the wearable holder, an alarm module in communication with the sensing module, and a fastener that fastens the wearable holder in a fastened position. The sensing module, in one embodiment, senses an energized electrical circuit when the sensing module is near the electrical circuit. In some embodiments, the alarm module generates an alarm in response to the sensing module sensing an energized electrical circuit. The fastener, in some embodiments, alternates between the fastened position and an unfastened position. In some embodiments, the fastener includes a conductive interface that activates the sensing module in response to the fastener being in the fastened position.

### BACKGROUND

1. Technical Field

This disclosure relates to safety equipment and more particularly relates to live electrical circuit detectors.

2. Description of the Related Art

Live electrical circuits pose a risk to those working wherever electrical wiring is present. Electricians, carpenters, plumbers, and other workers frequently work on or around electrical wiring, and if the wiring is energized, these workers may be subject to painful and dangerous shocks.

To avoid these risks, workers shut off circuits prior to working. However, sometimes electrical lines are energized during work. For example, a worker may forget to shut off a circuit, a third party may re-energize the circuit while the worker is working, or circuits may be mislabeled at a circuit box. Consequently, workers face the risk of electric shock even when they believe circuits are shut off.

One tool used by some workers to avoid working around live electrical circuits is a non-contact electric field detector. These detectors sense the presence of an electric field generated by a live circuit and generate an alarm when a live circuit is present. However, in order for these detectors to be effective, a user must decide to operate the detector before beginning work. If the user neglects to operate the detector, he or she will not detect live circuits. Additionally, if a third party re-energizes a circuit while the user is working, this live circuit will not be detected even if the user operated the detector before beginning work. Therefore, the user faces a continued risk of electric shock.

### SUMMARY

From the foregoing discussion, it should be apparent that a need exists for a device that detects a live electrical circuit. Beneficially, such a device would detect a live electrical circuit while a user works.

The present disclosure has been developed in response to the present state of the art, and in particular, in response to the problems and needs in the art that have not yet been fully solved by currently available voltage detectors. Accordingly, the present disclosure has been developed to provide an apparatus and system for a wearable electric circuit detection device that overcome many or all of the above-discussed shortcomings in the art.

The apparatus to detect a live electrical circuit is provided with a plurality of modules configured to functionally execute the necessary steps of detecting a live electrical circuit. These modules in the described embodiments include a wearable holder worn at or near a finger, a sensing module positioned on the wearable holder, an alarm module in communication with the sensing module, and a fastener that fastens the wearable holder in a fastened position at or near the finger. The sensing module, in one embodiment, senses a live electrical field in a live electrical circuit when the electrical circuit is energized and when the sensing module is near the electrical circuit. In some embodiments, the alarm module generates an alarm in response to the sensing module sensing an electrical field in the electrical circuit. The fastener, in some embodiments, alternates between the fastened position and an unfastened position. In some embodiments, the fastener includes a conductive interface that activates the sensing module in response to the fastener being in the fastened position.

In one embodiment, the wearable holder includes a glove worn on a hand, the hand including the finger. In another embodiment, the wearable holder includes a wrist strap worn around a wrist, the wrist near the finger. In one embodiment, the wearable holder includes a finger loop worn on the finger.

The fastener, in some embodiments, includes a snap. In one embodiment, the snap includes two removably fastenable structures of electrically conductive material. The snap, in some embodiments, activates the sensing module in response to contact between the two removably fastenable structures.

The fastener, in one embodiment, includes a hook and loop fastener. The hook and loop fastener, in one embodiment, includes an electrically conductive material and connecting the hook and the loop fastener activates the sensing module. In some embodiments, the conductive interface comprises two conductive surfaces. The two conductive surfaces, in one embodiment, contact one another in response to the fastener being in the fastened position. In certain embodiments, the conductive interface deactivates the sensing module in response to the fastener being in the unfastened position.

In some embodiments, the sensing module has a sensing radius of approximately twelve inches. The sensing module, in one embodiment, includes a flex circuit. In some embodiments, the apparatus includes a conductor connected between the sensing module and a sensing receiver, the sensing receiver reacting with the electric field to generate a signal. The sensing receiver, in one embodiment, is worn on a finger.

The apparatus, in one embodiment, includes a warning light activated by the alarm module in response to the sensing module sensing the electrical field. In certain embodiments, the apparatus includes a warning speaker activated by the alarm module in response to the sensing module sensing the electrical field.

A glove to detect a live electrical circuit is also presented. In one embodiment, the glove includes a sensing module on the glove, an alarm module in communication with the sensing module, and a fastener that fastens the glove in a fastened position. The sensing module, in one embodiment, senses an electrical field in an electrical circuit. In some embodiments, the alarm module generates an alarm in response to the sensing module sensing an electrical field in an electrical circuit. The fastener, in one embodiment alternates between a fastened position and an unfastened position and includes a conductive interface that activates the sensing module in response to the fastener being in the fastened position.

In one embodiment, the fastener includes a strap positioned near a wrist of the glove. In some embodiments, the conductive interface includes two conductive elements. The two conductive elements, in one embodiment, contact one another in response to the fastener being in the fastened position The glove, in one embodiment, includes a sensing receiver positioned on a finger of the glove. In some embodiments, the sensing receiver is in communication with the sensing module and the sensing receiver reacts with the electrical field in the electrical circuit when the electrical circuit is energized to generate a signal.

A wrist strap to detect a live electrical circuit is also provided. In some embodiments, the wrist strap includes a sensing module positioned on the wrist strap, an alarm module in communication with the sensing module, and a fastener that fastens the wrist strap in a fastened position. The sensing module, in one embodiment, senses an electric field in an electrical circuit when the electrical circuit is energized and when the sensing module is near the electrical circuit. In some embodiments, the alarm module generates an alarm in response to the sensing module sensing an electrical field in an electrical circuit. The fastener, in certain embodiments, alternates between the fastened position and an unfastened position and includes a conductive interface that activates the sensing module in response to the fastener being in the fastened position.

In one embodiment, the wrist strap includes a finger loop configured to be worn on a finger. The finger loop, in one embodiment, includes a sensing receiver in communication with the sensing module. In one embodiment, the sensing receiver is configured to react with the electrical field to generate a signal.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a wrist strap for detecting a live electrical circuit in accordance with the present invention;

FIG. 2 is a perspective view illustrating one embodiment of a glove for detecting a live electrical circuit in accordance with the present invention;

FIG. 3 is a perspective view illustrating one embodiment of a wrist strap with a finger loop for detecting a live electrical circuit in accordance with the present invention;

FIG. 4 is a circuit diagram illustrating one embodiment of use of the glove of FIG. 2; and

FIG. 5 is a circuit diagram illustrating one embodiment of the sensing module and alarm module of FIG. 1.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

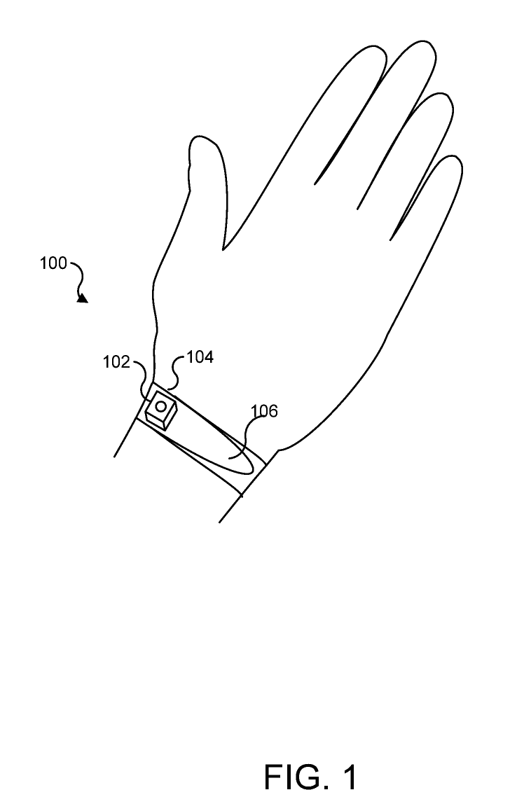

FIG. 1 is a perspective view illustrating one embodiment of a wrist strap for detecting a live electrical circuit. The wrist strap 100 includes a sensing module 102, an alarm module 104, and a fastener 106. The wrist strap 100 detects a live electrical circuit and generates an alarm if a signal with sufficient strength is detected from the electrical circuit and is above a threshold value. The wrist strap 100, in one example, is worn around a wrist.

The sensing module 102, in one embodiment, interacts with an electric field generated by a live electrical circuit to sense the presence of a live electrical circuit. The sensing module 102 may determine that a live electrical circuit is present in response to a signal generated from the live electrical circuit being above a threshold value.

The threshold value, in some embodiments, is relatively high. In this embodiment, the electric field must be relatively high in order for the sensing module 102 to determine that a live electrical circuit is present. For example, the threshold value may be a value that results in the sensing module 102 having a sensing radius of two inches. As used herein, “sensing radius” refers to a distance at which an electric wire, energized with 120 volts alternating current (AC) at 60 Hz, results in the sensing module 102 determining that an electric field is present. The threshold value is relatively low in some embodiments. For example, the threshold value may be a value that results in the sensing module 102 having a sensing radius of twelve inches. The threshold value may be set to any arbitrary value and have any resulting sensing radius.

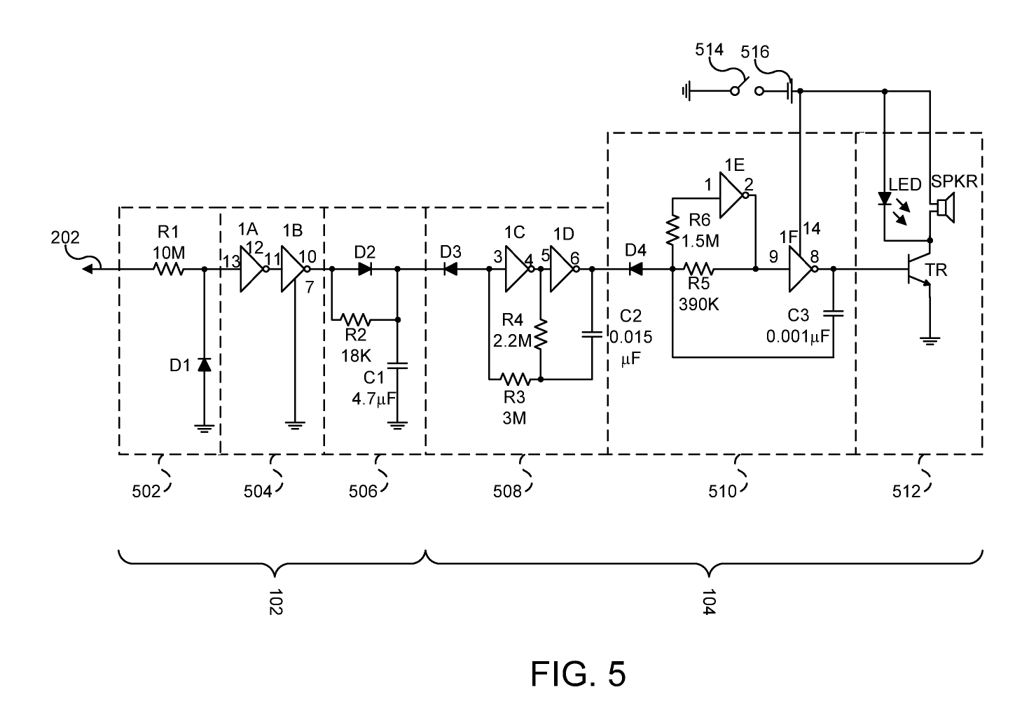

In the illustrated embodiment of FIG. 1, the sensing module 102 is attached to the wrist strap 100. An embodiment of the sensing module 102 is described in greater detail in relation to FIG. 5.

In some embodiments, the alarm module 104 generates an alarm indicating the presence of a live electrical circuit. The alarm module 104 may be activated by the sensing module 102 in response to the sensing module 102 sensing a live electrical circuit.

In one embodiment, the alarm module 104 includes a visible alarm indicator, such as a warning light that lights in response to the alarm module 104 being activated. For example, the alarm module 104 may include a light emitting diode (LED). In some embodiments, the alarm module 104 includes an audible alarm indicator, such as a warning speaker that generates a warning tone in response to the alarm module 104 being activated.

In the illustrated embodiment, the alarm module 104 is integrated with the sensing module 102. In an alternative embodiment, the alarm module 104 is in electrical communication with the sensing module 102. An embodiment of the alarm module 104 is described in greater detail in relation to FIG. 5.

The fastener 106, in one embodiment, fastens the wrist strap 100 around a user's wrist. The fastener 106 alternates between a fastened position and an unfastened position. Placed in the fastened position, the fastener 106 may form the wrist strap 100 into a loop, such that a user may wear the wrist strap 100 around his or her wrist. In some embodiments, the fastener 106 includes a conductive interface configured to activate the sensing module 102 in response to the fastener 106 being in the fastened position. The conductive interface may deactivate the sensing module 102 in response to the fastener 106 being placed in an unfastened position.

The fastener 106 may include any type of fastener. For example, the fastener 106 may include a hook and loop fastener, a snap, a compliant fastener, or the like. A hook and loop fastener may include an electrically conductive material, and connecting the hook and loop fastener may activates the sensing module. The conductive interface may include any type of conductive interface. For example, the fastener 106 may include two conductive areas that contact one another in response to the fastener 106 being in the fastened position.

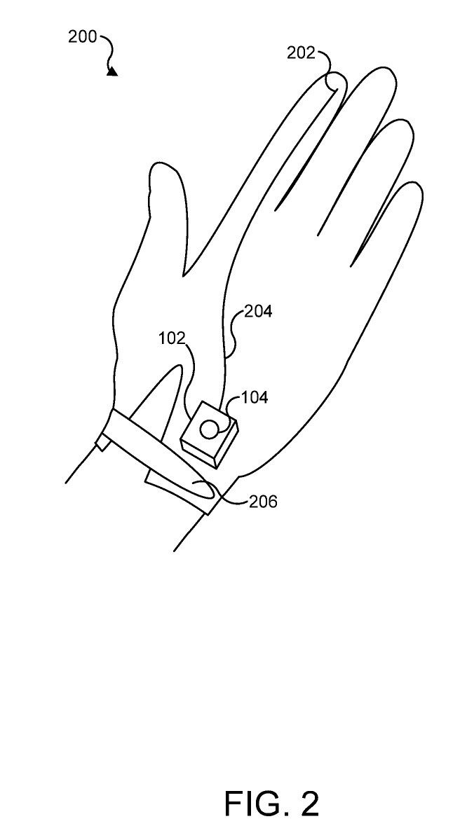

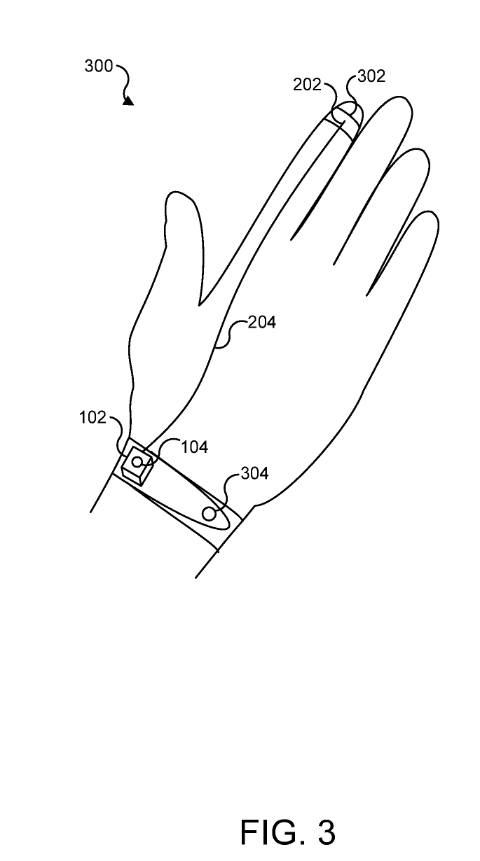

FIG. 1 illustrates an embodiment of a wrist strap 100. In some embodiments, the sensing module 102 is attached to another type of wearable holder configured to be worn on or near a finger. For example, FIG. 2 illustrates a wearable holder that includes a glove. In another example, FIG. 3 illustrates another type of wrist strap with a finger loop.

FIG. 2 is a perspective view illustrating one embodiment of a glove 200 for detecting a live electrical circuit. The glove 200 includes a sensing module 102, an alarm module 104, a sensing receiver 202, a conductor 204, and a fastener 206. The sensing module 102 and alarm module 104 may be similar to the same numbered components described in relation to FIG. 1. The glove 200 generates an alarm in response to determining that a live electrical circuit is present.

The sensing receiver 202, in some embodiments, senses an electric field generated by a live electrical circuit. For example, the sensing receiver 202 may be an antenna. The sensing receiver 202 modifies the sensing radius of the sensing module 102. In the illustrated embodiment, the sensing receiver 202 is positioned on a finger of the glove 200, resulting in detection of electric fields close to the finger of the glove 200. The sensing receiver 204 may be positioned at any location. For example, the sensing receiver 204 may be positioned on a thumb of the glove 200. In some embodiments, the glove 200 includes a plurality of sensing receivers 202.

In one embodiment, the sensing receiver 202 is connected to the sensing module 102 by a conductor 204. The conductor 204 may be any type of electrical pathway, such as one or more wires or a flex circuit.

The fastener 206, in one embodiment, fastens the glove 200. Placed in a fastened position, the fastener 206 may secure the glove 200 on a user's hand. In some embodiments, the fastener 206 includes a conductive interface configured to activate the sensing module 102 in response to the fastener 106 being in the fastened position. The conductive interface may deactivate the sensing module 102 in response to the fastener 106 being placed in an unfastened position.

FIG. 3 is a perspective view illustrating one embodiment of a wrist strap 300 with a finger loop 302 for detecting a live electrical circuit. The wrist strap 300 includes a sensing module 102, an alarm module 104, a finger loop 302, a sensing receiver 202, a conductor 204, and a fastener 304. The sensing module 102 and the alarm module 104 may be similar to the same numbered components described in relation to FIG. 1. The sensing receiver 202 and the conductor may be similar to the same numbered components described in relation to FIG. 2. The wrist strap 300 generates an alarm signal in response to detecting a live electrical circuit.

The finger loop 302, in one embodiment, is positionable on a finger and secures the sensing receiver 202 on the finger. The finger loop 302 may include any type of material capable of being positioned on a finger. For example, the finger loop 302 may include a compliant material that stretches around a finger and secures the sensing receiver 202 on the finger. The sensing receiver 202, in one embodiment, is attached to the finger loop 302.

The fastener 302, in one embodiment, includes a snap. The snap includes two structures that interact with one another to secure the fastener 302 in response to application of pressure to force the two structures together. The snap may include conductive material and form conductive interface. The conductive interface may activate the sensing module 102 in response to the two structures of the snap being in contact with one another. The conductive interface may deactivate the sensing module 102 in response to the two structures of the snap being separated from one another.

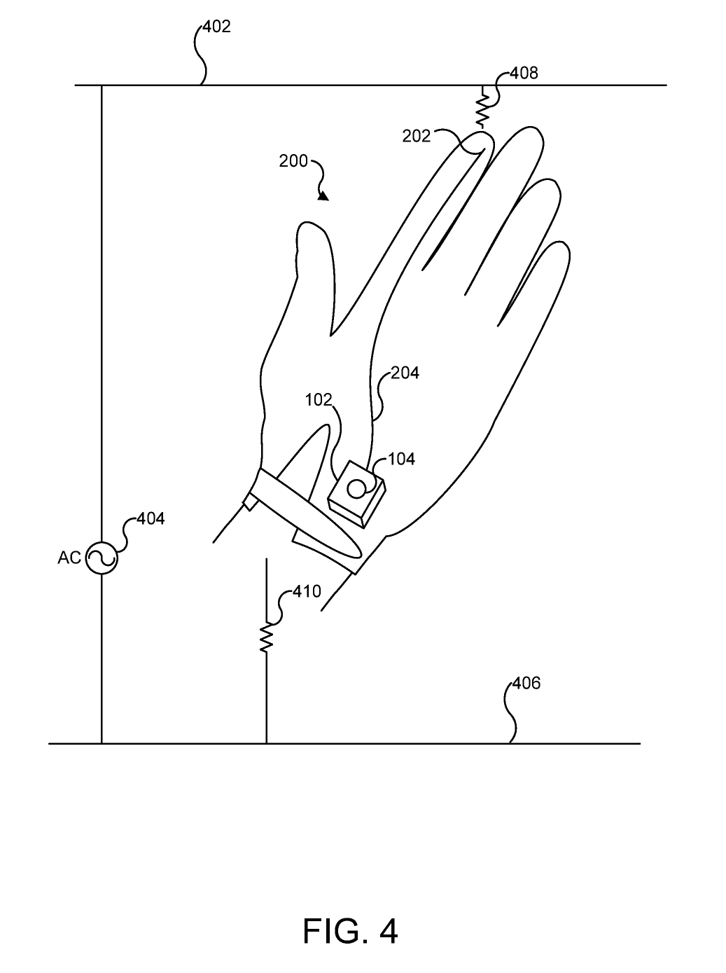

FIG. 4 is a circuit diagram illustrating one embodiment of use of the glove 200 of FIG. 2. The circuit diagram includes the glove 200, an energized electrical line 402, a voltage source 404, a ground 406, a first impedance 408, and a second impedance 410.

In one embodiment, the energized electrical line 402 is electrically coupled to the voltage source 404 provided between the energized electrical line 402 and ground 406. The voltage source 504 may be any type of voltage source used home or business electrical wiring. For example, the voltage source 404 may be a voltage supply operating in the range of 120 or 220 volts AC at either 50 or 60 Hertz, or in various other voltage source configurations used in electrical supply configurations.

In response to the glove 200 approaching the energized electrical line 402, the glove 200 is coupled to the energized electrical line 402 through the first impedance 408 caused by an air gap between the energized electrical line 402. The glove 200 is further coupled to ground 406 through the second impedance 410 comprising generally an impedance from a user of the glove 200 and the floor of the working environment. Therefore, a complete circuit exists from the power source 404, through the energized electrical line 402, through the air to the glove 200, from the glove 200 to the user and through the user to ground 406, which is the ground of the voltage source 404.

Based on Kirchoffs law, which states that the sum of the voltage rises (sources) must equal the sum of the voltage drops around a closed loop circuit, the voltage drops across the first and second impedances 408, 410 and an impedance inherent to the glove add to be substantially equivalent to that of the voltage source 404. Here, the voltage drop across the body of the user is neglected, as the impedance of the human body is comparatively very low. The first and second impedances 408, 410, the impedance of the glove 200, and the associated voltage drops can vary widely in response to moving the glove about in the vicinity of the energized electrical line 402.

If the glove 200 is far from the energized electrical line 402, the voltage drop across the first impedance 408 is substantially equivalent to that of the voltage source 404 because the first impedance 408 of the air gap is much larger than that of the other impedances. As the glove 200 is moved closer to the energized electrical line 402, the first impedance 408 becomes smaller and current begins to flow in the circuit. If the impedance across the glove 200 is large, a voltage drop will occur. In response to the voltage drop rising above a threshold level, the sensing module 102 of the glove 200 is activated as described above, thereby causing visual and/or audible signals to be provided by the alarm module 104.

FIG. 5 is a circuit diagram illustrating one embodiment of the sensing module 102 and alarm module 104 of FIG. 1. The sensing module 102 includes a voltage divider 502, an inverter circuit 504, and a rectification circuit 506. The alarm module 104 includes a low frequency oscillator 508, a high frequency oscillator 510, and an alarm activation circuit 512. The sensing module 102 and the alarm module 104 may be activated by a switch 514 which applies power from a battery 516 to the circuit.

The sensing module 102, in one embodiment, receives an input alternating current (AC) voltage from the sensing receiver 202, compares the input voltage to a threshold level and activates the alarm module 104 when the input exceeds a threshold value. The input voltage provides an indication that the sensing module is near an energized wire as described above in relation to FIG. 4.

The voltage divider 502, in one embodiment, includes a first resistor R1 which receives an input voltage indicative of the proximity of the tool to a live wire, and a first diode D1 coupled between the output of the first resistor R1 and ground. The voltage divider 502 reduces the input voltage to a level suitable for use in conjunction with the digital circuitry described below. As a function of the input voltage, the voltage across the first diode D1 varies from substantially zero when the sensing receiver 202 is not in proximity with a live electrical wire, to a threshold value of a few volts when the sensing receiver 202 is near a live wire, as described above. In some embodiments, the value of the first resistor R1 is selected to prevent excessive current flow through the sensing module 102 when the sensing receiver 202 touches a live wire, while also providing a relatively small voltage drop, but assuring that sufficient voltage is provided to activate the sensing module 102. For example, for an expected input voltage provided by a wire operating in the range between 120 and 220 VAC, the resistor R1 may have a value of 10 Mega Ohms.

In one embodiment, the voltage across the first diode D1 provides an input signal to the inverter circuit 504, which includes complementary metal-oxide-semiconductor (CMOS) first and second logic inverter gates 1A and 1B. The first logic inverter gate 1A switches between a logic high and a logic low state as the voltage across the first diode D1 reaches a threshold value. For example, the threshold value may be in a range between one and two volts. As noted above, the voltage across the first diode D1 and, therefore, the input voltage to the first logic inverter gate 1A varies with the distance between the sensing receiver 202 and a live electrical wire. When the sensing receiver 202 is not near a live wire, the voltage across the first diode D1 is substantially zero and therefore below the threshold voltage. In this state, the output of the first logic inverter gate 1A will be high because of the inverting action of the logic gate. When the sensing receiver 202 is placed near a live wire with a voltage impressed on it, the voltage across the first diode D1 rises above the threshold voltage to trip the first logic inverter gate 1A causing the output of the first logic inverter gate 1A to go low. A logic low output from the first logic inverter gate 1A therefore indicates that a voltage is being sensed by the sensing module. The second logic inverter gate 1B buffers and inverts the signal, thereby providing a logic high output signal from the inverter circuit 504 when the sensing receiver 202 is near a live wire.

The output of the second logic inverter gate 1B, in some embodiments is received by the rectifying circuit 506, which converts the alternating voltage signal to a direct current (DC) voltage using a rectifying circuit comprising a second diode D2, a second resistor R2, and a first capacitor C1. The rectifying circuit 506 provides a DC voltage across the first capacitor C1, therefore, in response to the sensing receiver 202 being near an energized live wire.

In one embodiment, the output of the rectifying circuit 506 is received by the alarm module 104, which provides a visual or audio signal. In some embodiments, the alarm module 104 includes low and high frequency oscillator circuits 508 and 510.

The low frequency oscillator circuit 508, in one embodiment, includes third and fourth logic inverter gates 1C and 1D, along with a third diode D3, a third resistor R3, a fourth resistor R4, and a second capacitor C2. The low frequency oscillator circuit 508 is activated or enabled when a DC voltage is present on the first capacitor C1. When activated, the low frequency oscillator circuit 508 produces an output signal having a frequency in the range of 1 to 5 Hertz.

In one embodiment, the output signal of the low frequency oscillator circuit 508 enables the high frequency oscillator circuit 510, including fifth and sixth logic inverter gates 1E and 1F and a sixth resistor R6, a fourth diode D4, a fifth resistor R5, and a third capacitor C3. The high frequency oscillator circuit 510 produces an output signal in an audio frequency range. The output of the high frequency oscillator circuit 510 drives the alarm activation circuit 512 by activating a transistor TR, which in turn is connected to a speaker SPKR and an LED. Hence, when the sensing receiver 202 is placed near an energized electrical circuit, the LED is activated and the speaker will produce a sound in the audio range produced by the high frequency oscillator circuit 510.

Although the alarm module 104 has been described to include a high and low frequency oscillator 508, 510, a number of different alarm circuits can be constructed to provide similar functions. For example, if only a visual indicator such as the LED is used, a transistor switch to an LED can be used.

In some embodiments, the battery 516 powers the circuit. The battery 516 may provide a 3V DC power supply. The negative terminal of the battery 516 is connected to circuit common or ground through the switch 514 and, therefore, the switch 514 may be activated to energize the circuit. In some embodiments, the switch 514 is actuated by a fastener 106, and the switch 516 is activated in response to the fastener 106 being placed in a fastened position and deactivated in response to the fastener 106 being placed in an unfastened position.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A detection device for detecting a live electrical circuit, the detection device comprising:
a wearable holder worn at or near a finger;
a sensing module disposed on the wearable holder, the sensing module sensing an electrical field in an electrical circuit when the electrical circuit is energized and when the sensing module is near the electrical circuit;
an alarm module in communication with the sensing module, the alarm module generating an alarm in response to the sensing module sensing an electrical field in the electrical circuit;
a fastener alternating between a fastened position and a unfastened position, wherein the fastener fastens the wearable holder in the fastened position at or near the finger; and
wherein the fastener comprises a conductive interface that activates the sensing module in response to the fastener being in the fastened position.

2. The detection device of claim 1, wherein the wearable holder comprises a glove worn on a hand, the hand comprising the finger.

3. The detection device of claim 1, wherein the wearable holder comprises a wrist strap worn around a wrist, the wrist near the finger.

4. The detection device of claim 1, wherein the wearable holder comprises a finger loop worn on the finger.

5. The detection device of claim 1, wherein the fastener comprises a snap.

6. The detection device of claim 5, wherein the snap comprises two removably fastenable structures of electrically conductive material, the snap activating the sensing module in response to contact between the two removably fastenable structures.

7. The detection device of claim 1, wherein the fastener comprises a hook and loop fastener, wherein the hook and loop fastener comprises an electrically conductive material and connecting the hook and loop fastener activates the sensing module.

8. The detection device of claim 1, wherein the conductive interface comprises two conductive surfaces, wherein the two conductive surfaces contact one another in response to the fastener being in the fastened position.

9. The detection device of claim 1, wherein the conductive interface deactivates the sensing module in response to the fastener being in the unfastened position.

10. The detection device of claim 1, wherein the sensing module has a sensing radius of approximately twelve inches.

11. The detection device of claim 1, wherein the sensing module comprises a flex circuit.

12. The detection device of claim 1, further comprising a conductor connected between the sensing module and a sensing receiver, the sensing receiver reacting with the electric field to generate a signal.

13. The detection device of claim 12, wherein the sensing receiver is worn on a finger.

14. The detection device of claim 1, further comprising a warning light activated by the alarm module in response to the sensing module sensing the electrical field.

15. The detection device of claim 1, further comprising a warning speaker activated by the alarm module in response to the sensing module sensing the electrical field.

16. A glove to detect a live electrical circuit, the glove comprising:
a sensing module disposed on the glove, the sensing module sensing an electrical field in an electrical circuit when the electrical circuit is energized and when the sensing module is near the electrical circuit;
an alarm module in communication with the sensing module, the alarm module generating an alarm in response to the sensing module sensing an electrical field in the electrical circuit;
a fastener alternating between a fastened position and an unfastened position, wherein the fastener fastens the glove in the fastened position; and
wherein the fastener comprises a conductive interface that activates the sensing module in response to the fastener being in the fastened position.

17. The glove of claim 16, wherein the fastener comprises a strap disposed near a wrist of the glove and wherein the conductive interface comprises two conductive elements, wherein the two conductive elements contact one another in response to the fastener being in the fastened position.

18. The glove of claim 16, further comprising a sensing receiver disposed on a finger of the glove, the sensing receiver in communication with the sensing module, the sensing receiver reacting with the electrical field in the electrical circuit when the electrical circuit is energized to generate a signal.

19. A wrist strap to detect a live electrical circuit, the wrist strap comprising:
a sensing module disposed on the wrist strap, the sensing module sensing an electrical field in an electrical circuit when the electrical circuit is energized and when the sensing module is near the electrical circuit;
an alarm module in communication with the sensing module, the alarm module generating an alarm in response to the sensing module sensing an electrical field in the electrical circuit;
a fastener alternating between a fastened position and a unfastened position, wherein the fastener fastens the wrist strap in the fastened position; and
wherein the fastener comprises a conductive interface that activates the sensing module in response to the fastener being in a fastened position.

20. The wrist strap of claim 19, further comprising a finger loop configured to be worn on a finger, the finger loop comprising a sensing receiver in communication with the sensing module, the sensing receiver configured to react with the electrical field to generate a signal.
